(19) United States
(12) Patent Application Publication
(10) Pub. No.: US 2006/0214925 A1
(43) Pub. Date: Sep. 28, 2006

(54) Touch panel

(76) Inventors: Yasunori Taninaka, Tokyo (JP); Etsuo Ogino, Tokyo (JP)

Correspondence Address: LAW OFFICES;WHITHAM, CURTIS & CHRISTOFFERSON, P.C., SUITE 340, 11491 SUNSET HILLS ROAD, RESTON, VA, 20190, US

(21) Appl. No.: 11/370,875

(22) Filed: Mar. 9, 2006

(30) Foreign Application Priority Data
Mar. 22, 2005 (JP) P2005-081241

(51) Int. Cl. G09G 5/00

(52) U.S. Cl. 345/173

(57) ABSTRACT

The invention provides a touch panel including a first transparent substrate provided with a transparent conductive film on one surface thereof; a second transparent substrate provided with a transparent conductive film on one surface thereof, said first substrate and said second substrate being fixed in parallel with each other so that said transparent conductive films are opposed to each other; and a supporting member to regulate a distance between said opposite substrates, wherein a first four-layered transparent dielectric film is formed between a surface of at least one of the first and second transparent substrates and the corresponding transparent conductive film, a second four-layered transparent dielectric film is formed on an opposite surface to the surface on which the transparent conductive film is formed.

### BACKGROUND OF THE INVENTION

1. Field of the Invention

The invention relates to a touch panel used for an input device to various electronic devices.

2. Related Art

So-called touch panel is provided by opposing substrates having transparent conductive films to each other, and functions as contact points of electric switch, by contacting transparent conductive films with each other, when one of the substrates is bent by being locally pressed with a pen or finger.

FIG. 5 shows a schematic sectional view showing a construction of a conventional touch panel 110. A transparent conductive film 142 is provided on a surface of a transparent substrate 120. A second transparent substrate 122 is fixed so as to be in parallel with the first transparent substrate 120. An insulating spacer 150 is inserted between the first and second transparent substrates 120,122 so as to be apart from each other at a predetermined distance. A second transparent conductive film 144 is formed on a surface of the second transparent substrate 122 that faces to the first substrate 120. When soda-lime glass is used for a transparent substrate, it is typically performed that SiO₂ film or the like is inserted between the transparent substrate and the transparent conductive film in order to prevent dissolution of alkali ions (not illustrated by drawings).

When a predetermined position on the surface of the second transparent substrate 122 is pressed with a finger or a pen, the second transparent substrate 122 that has a small thickness is bent, and an electric contact between the transparent conductive films 142, 144 are obtained. At this time, by providing dot spacers 170 on the transparent conductive films 142, the contact is obtained only at the predetermined position at which the second transparent substrate 142 is pressed. On the other hand, circuit patterns are formed on the spacer 150 so as to be in contact with the transparent conductive film 142 or the transparent conductive film 144, and it is connected with a flexible circuit board 160. Contact or non-contact state between the transparent conductive films 142, 144 is picked up as signals to external circuits through electric wiring on the flexible circuit board 160.

In such a touch panel, a display of letters or figures provided outside of the transparent substrate is visually observed through the transparent conductive films, and a signal is input by pressing a required position. Accordingly, high transmittance is required for transparent conductive films for touch panels to obtain high level of visibility.

To obtain the high transmittance, one option is to reduce thickness of the transparent conductive film. However, if the thickness is made 10 nm or lower, stability and uniformity in resistance of the film is deteriorated. Therefore, there is a limitation to obtain high transmittance by reducing the film thickness. In order to solve this problem, JP H07-242442A, for example, discloses to improve the transmittance by forming a high refractive index layer and a low refractive index layer of transparent dielectric materials on the substrate, and forming a transparent conductive film on these layers.

However, in the method where the high refractive index layer and the low refractive index layer of the dielectric materials and the transparent conductive film are formed on the substrate sequentially, a large peak is formed in the visible range in the transmittance curve. Consequently, there is a problem that a color tone is changed when the touch panel is employed for a color display because the light passing the layers of the films in the touch panel is colored.

### SUMMARY OF THE INVENTION

The present invention is made to solve the above problems. The object of the invention is to provide a touch panel in which a high transmittance is obtained and light color in passing the touch panel is achromatic, and more specifically, to provide a color display touch panel having high visibility.

To solve the above problems, the present invention provides the following constructions. A touch panel of the invention is provided with the following basic structure.

A first transparent substrate provided with a transparent conductive film on one surface thereof and a second transparent substrate provided with a transparent conductive film on one surface thereof are fixed in parallel with each other so that the transparent conductive films are opposed to each other. The transparent conductive films of the first and second transparent substrates are electrically contacted with each other, when the first transparent substrate is bent by being locally pressed with a pen or finger on the surface that is opposite to the surface on which the transparent conductive film is provided. A supporting member is provided at a predetermined position for regulating the distance between the opposing transparent substrates to realize the above operation.

In such a touch panel, a first four-layered transparent dielectric film is formed between the substrate surface on a side of which the transparent conductive film is provided and the transparent conductive film in at least one substrate of said first and second transparent substrates, a second four-layered transparent dielectric film is formed on an opposite surface to the surface on which the transparent conductive film is formed in this transparent substrate.

Thus, in at least one of the transparent substrates, by forming the four-layered transparent dielectric films on opposite surface of this transparent substrate, a touch panel in which an extremely high transmittance is obtained and light color in passing the touch panel is achromatic can be provided. In particular, a color display touch panel having a high visibility can be provided.

Further, in the above basic structure, a refractive index of this transparent substrate is in a range of 1.45-1.70, refractive indices of a first layer and a third layer in said first and second transparent dielectric film that are counted from a side of said transparent substrate are in a range of 1.6-2.5, refractive indices of a second layer and a fourth layer are in a range of 1.35-1.5, and a refractive index of said transparent conductive film is in a range of 1.7-2.2. The refractive indices of the first layer and third layer in the first and second transparent dielectric films are selected to be higher than the refractive indices of the transparent substrate, the second layer and the fourth layer, and the refractive index of the transparent conductive film is selected to be higher than the refractive index of said fourth layer in the transparent dielectric films. In addition, a film thickness of the first layer in the first and second transparent dielectric films is in a range of 7-45 nm, a film thickness of the second layer is in a range of 10-63 nm, a film thickness of the third layer is in a range of 9-125 nm, a film thickness of the fourth layer is in a range of 20-130 nm, and a film thickness of the transparent conductive film is in a range of 10-30 nm.

More specifically, it is preferable for the thickness of the layers in the second transparent dielectric film, that the thickness of the first layer is in a range of 7-18 nm, the thickness of the second layer is in a range of 37-63 nm, the thickness of the third layer is in a range of 9-23 nm and the thickness of the fourth layer is in a range of 81-130 nm.

Also, for the thickness of the layers in the first transparent dielectric film which is served in combination with the second transparent dielectric film, it is preferable that the thickness of the first layer is in a range of 10-18 nm, the thickness of the second layer is in a range of 21-35 nm, the thickness of the third layer is in a range of 96-119 nm, and the thickness of the fourth layer is in a range of 33-51 nm.

Further, it is preferable for the thickness of the layers in the first transparent dielectric film, that the thickness of the first layer is in a range of 10-18 nm, the thickness of the second layer is in a range of 37-56 nm, the thickness of the third layer is in a range of 14-25 nm and the thickness of the fourth layer is in a range of 56-85 nm.

In other words, by forming sequentially a high refractive index layer, a low refractive index layer, a high refractive index layer, a low refractive index layer and a transparent conductive film on one surface of a substrate, as well as by forming sequentially a high refractive index layer, a low refractive index layer, a high refractive index layer and a low refractive index layer on opposite surface of the substrate, a touch panel in which a high transmittance is obtained and light color in passing the touch panel is achromatic can be provided.

In the touch panel having the aforesaid laminate films, it is preferable that chromatics indexes a* value and b* value derived for light C with 2 degrees of view angle that is transmitted through said transparent substrate on opposite surfaces of which said transparent dielectric films are laminated, are in a range of −1 through +1 based on an indication method of a body color according to a color representation system of L*a*b* provided by Japanese Industrial Standards (JIS Z 8729).

By setting chromatics indexes in the above range, the light color in passing the touch panel can be achromatic.

Further, it is preferable that an average transmittance for light having a wavelength range of 400-650 nm to the transparent substrate having the aforesaid laminate films is not less than 95%.

By the above construction, a touch panel in which light color in passing the touch panel is achromatic and which has a high average transmittance for light of the visible range can be provided.

According to the invention, by forming laminate films of dielectric materials on opposite sides of a substrate, a touch panel can be configured with a substrate having a transparent conductive film in which a high transmittance is obtained and light color in passing the substrate is achromatic. Accordingly, it is possible to provide a touch panel having high visibility and suitable for color display.

### BRIEF DESCRIPTION OF THE DRAWINGS

FIG. 1 shows a schematic sectional view of a touch panel according to the invention.

FIG. 2 shows a construction of a dielectric film according to the invention.

FIG. 3 shows transmittance characteristics of the substrate with transparent conductive film according to the examples of the invention.

FIG. 4 shows transmittance characteristics of the substrate with transparent conductive film according to the comparative examples of the invention.

FIG. 5 shows a schematic sectional view of a conventional touch panel.

### DETAILED DESCRIPTION OF THE PREFERRED EMBODIMENTS

Hereinafter, the invention will be described in detail.

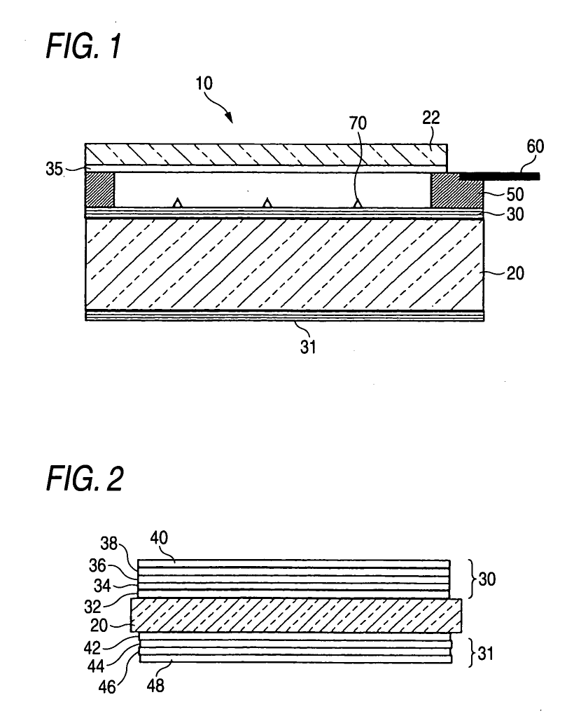

FIG. 1 shows a schematic sectional view showing an embodiment of a touch panel 10 according to the invention. A laminate film 30 constituted by a first four-layered transparent dielectric film and a first transparent conductive film (ITO film) are provided on one surface of a first transparent substrate 20 made of soda-lime glass. Another laminate film 31 constituted by a four-layered transparent dielectric film is provided on a surface opposite to this surface of the substrate 20.

A second transparent substrate 22 that is also made of soda-lime glass is adhered in parallel with the substrate 20. An insulating spacer 50 is inserted between the first and second transparent substrates 20,22 so as to be apart from each other at a predetermined distance. A transparent conductive film 35 is provided on a surface of the second transparent substrate 22 facing the first transparent substrate 20. In other words, the transparent conductive films are opposed to each other, so that an electric contact therebetween can be obtained when the transparent substrate 22 is bent when a predetermined position on the surface of the second transparent substrate 22 is pressed with a finger or a pen.

The spacer 50 that serves as supporting member to determine or regulate a distance between the transparent substrates 20,22 is located at a position such that the transparent substrates 20,22 can be in contact with each other when one of the substrates is bent by a local pressure.

At the same time, by providing insulating dot spacers 70 on the first transparent conductive film, the contact between the transparent substrates can be obtained only at the predetermined position and contact at other positions is prevented.

Wiring patterns are provided on the spacer 50 to connected with the transparent conductive films respectively, and the wiring patterns are connected with a flexible circuit board 60.

FIG. 2 shows a schematic sectional view showing a construction of the laminate films 30,31 according to the invention.

A high refractive index transparent dielectric film 32 as first layer, a low refractive index transparent dielectric film 34 as second layer, a high refractive index transparent dielectric film 36 as third layer, a low refractive index transparent dielectric film 38 as fourth layer are sequentially laminated on one surface of the transparent substrate 20. Then, as fifth layer, a transparent conductive film 40 is laminated. In other words, a laminate film is configured by alternately forming on the transparent substrate each two layers of high refractive index transparent dielectric films and low refractive index transparent dielectric films, and further forming the transparent conductive film thereon.

Further, a high refractive index transparent dielectric film 42 as first layer, a low refractive index transparent dielectric film 44 as second layer, a high refractive index transparent dielectric film 46 as third layer and a low refractive index transparent dielectric film 42 as fourth layer are sequentially laminated on the opposite surface of the transparent substrate 20. In other words, a laminate film is configured by alternately forming on the transparent substrate each two layers of high refractive index transparent dielectric films and low refractive index transparent dielectric films, and further forming the transparent conductive film thereon.

The transparent substrate 20 can be made of soda-lime glass (refractive index: 1.52), other glasses having refractive index in a range of 1.45-1.70, or a transparent resin materials. As the resin materials, polycarbonate (refractive index: 1.59), polyethylene terephthalate (refractive index: 1.66) or the like can be listed.

As high refractive index transparent dielectric films, oxide dielectric material such as Al₂O₃, TiO₂, Nb₂O₅, TaO₅ etc. that have higher refractive indices than that of the transparent substrate, or combined oxide materials including the above substances as main components can be used. However, materials for high refractive index transparent dielectric films are not limited to the above substances. As low refractive index transparent dielectric films, SiO₂, MgF₂ etc. that have a refractive index in a range of 1.35-1.50 can be used. However, materials for the low refractive index transparent dielectric films are not limited to the above substances. As transparent conductive film, it is desirable that material having a refractive index in a range of 1.7-2.2 is used such as indium tin oxide (ITO). However, material for transparent conductive film is not limited to the above substance.

To form films having different refractive indices, forming methods as generally known such as spattering, electronic beam evaporation can be used. Hereinafter, the description of specific examples of the laminate films will be made in detail.

### EXAMPLE 1

In this example, the description will be made to form transparent dielectric films and a transparent conductive film by spattering methods.

First, three kinds of targets, Si, Ti and ITO are installed in an inline spattering device. A soda-lime glass as a transparent substrate is mounted in the device. Then the device is evacuated. After that, O₂ gas mixed with 30% of Ar gas was introduced in the device, and electric discharge was performed by supplying DC power to the Ti target under a condition that an internal pressure of the device is 0.3 Pa. Incidentally, electric discharge power was set to be 2 kW.

A soda-lime glass substrate with a thickness of 1.1 mm was transported to pass a front face of the target to thereby form a TiO₂ film (refractive index: 2.50) with a thickness of 13.1 nm.

Next, DC power was supplied to Si target at the atmosphere of O₂ gas mixed with 30% of Ar gas. Electric discharge was performed. Electric discharge power was 2 kW. The soda-lime glass substrate on which the TiO₂ film was formed was transported to pass a front face of the Si target to thereby form a SiO₂ film (refractive index: 1.46) with a thickness of 46.3 nm.

Further, the soda-lime glass substrate was transported to pass the front face of the Ti target to thereby form a TiO₂ film (refractive index: 2.50) with a thickness of 17.8 nm.

Next, DC power was supplied to Si target at the atmosphere of O₂ gas mixed with 30% of Ar gas. Electric discharge was performed. Electric discharge power was 2 kW. The soda-lime glass substrate on which the TiO₂ film was formed was transported to pass a front face of the Si target to thereby form a SiO₂ film (refractive index: 1.46) with a thickness of 106.0 nm.

After that, reverting the substrate, a TiO₂ film with a thickness of 12.4 nm, subsequently a SiO₂ film with a thickness of 28.9 nm, a TiO₂ film with a thickness of 106.8 nm and a SiO₂ film with a thickness of 42.3 nm were formed on the opposite surface of the substrate in such a manner as described above.

Further, after evacuating the gas in the device, Ar gas mixed with 2% of O₂ gas was introduced in the device and the internal pressure of the device was adjusted to be 0.3 Pa. Then, the direct current power was supplied to the ITO target to perform electric discharge. The electric discharge power was adjusted to be 2 kW. The soda-lime glass to which each 2 layers of TiO₂ films and SiO₂ films were formed was transported to pass a front face of the ITO target to thereby form an ITO layer (refractive index: 1.93) with a thickness of 20 nm.

By the process as described above, laminate films configured: TiO₂/SiO₂/TiO2/SiO2/ITO and TiO₂/SiO₂/TiO₂/SiO2 are formed with the film thickness shown in Table 1 on the opposite sides of the soda-lime glass substrate.

Incidentally, although a first laminate film is formed on one surface of the transparent substrate and subsequently a second laminate film is formed on the opposite surface of the transparent substrate by reverting the substrate in the above film formation process, the film formation process of the invention is not limited to the above process. By using a device in which targets are installed on both sides of the substrate, the laminate films may be formed on the opposite sides of the transparent substrate as the same time.

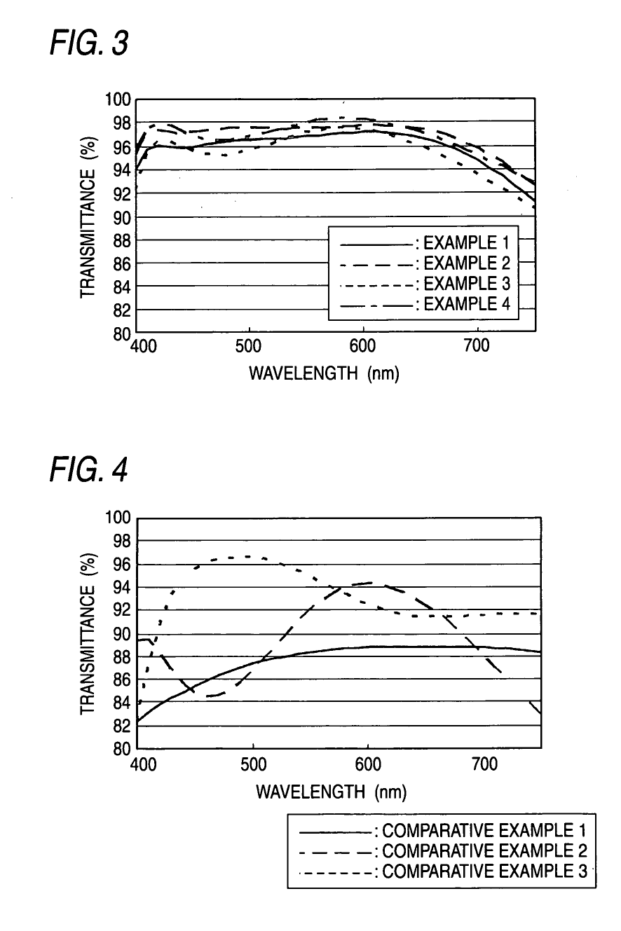

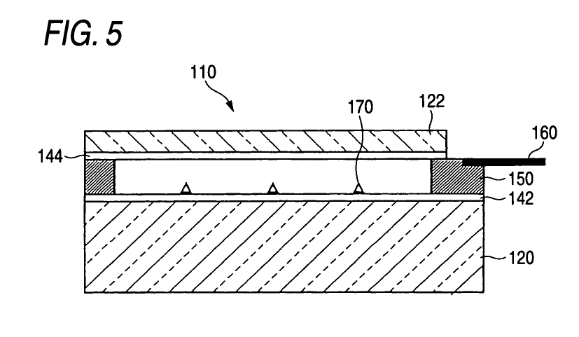

Spectral transmittances were measured for the obtained substrate with laminate films. The measurement results are shown in FIG. 3. The result shows that the substrate has high transmittance about 97% in the wavelength range of 500-600 nm. Also, the substrate has a high average transmittance of 96.5% (see Table 2) over the visible light wavelength range of 450-600 nm.

Further, the chromatic indexes were derived based on an indication method of a body color according to a color representation system of L*a*b* provided by Japanese Industrial Standards (JIS Z 8729, Color Display Method—L*a*b* color representation system and L*u*v* color representation system). Standard light C is irradiated from one side of the panel, and the light transmitted though the panel was measured with 2 degrees of view angle on the opposite side of the panel. The chromatic indexes a* value and b* value derived are shown in Table 2. Transmittance spectrum shows little variation and high transmittance in the visible wavelength range. In addition, since the a* value and b* value are small, it is understood that the laminate film of this example has high transmittance and light color in passing the laminate film is achromatic.

### EXAMPLE 2

The description will be made in a method to form dielectric multi-layered films by using a vacuum evaporation method.

By the vacuum evaporation method, a TiO₂ film (thickness: 11.4 nm) was formed on a soda-lime glass substrate with a thickness of 1.1 nm, and subsequently a MgF₂ film (thickness: 50.8 nm, refractive index: 1.38) was formed. Similarly, a TiO₂ film (thickness: 14.0 nm) and a MgF₂ film (thickness: 118.0 nm) were formed.

After that, reverting the substrate, a TiO₂ film (film thickness: 13.7 nm) was formed, and subsequently a MgF₂ film (film thickness: 26.7 nm, refractive index: 1.38) was formed. Similarly, a TiO₂ film (thickness: 20.0 nm) was formed to obtain a laminate film having the construction as shown in Table 1. FIG. 3 shows measurement result of transmittance of the laminate film, and Table 2 shows average transmittance as well as a* value and b* value. Average transmittance in the visible wavelength range is high to be 97.4% and the light color passing the film is achromatic.

### EXAMPLE 3

By using the spattering method as described in Example 1, a TiO₂ film (flim thickness: 11.6 nm), a SiO₂ film (film thickness: 51.2 nm), a TiO₂ film (film thickness: 16.2 nm) and a SiO₂ film (film thickness: 108.4 nm) are sequentially formed on a soda-lime glass substrate with a thickness of 1.1 mm. Then, reverting the substrate, a TiO₂ film (film thickness: 13.6 nm), a SiO₂ film (film thickness: 47.1 nm), a TiO₂ film (film thickness: 13.6 nm), a SiO₂ film (film thickness: 47.1 nm), a TiO₂ film (film thickness: 20.8 nm), a SiO₂ film (film thickness: 70.5 nm), and an ITO film (film thickness: 15.0 nm) are sequentially formed to obtain a laminate film as shown in Table 1.

FIG. 3 shows measurement result of transmittance of the laminate film, and Table 2 shows average transmittance as well as a* value and b* value. Average transmittance in the visible wavelength range is high to be 96.3% and the light color passing the film is achromatic.

### EXAMPLE 4

By using the vacuum evaporation method as described in Example 2, a TiO₂ film (film thickness: 10.5 nm), a MgF₂ film (film thickness: 52.8 nm), a TiO₂ film (film thickness: 13.5 nm) and a MgF₂ film (film thickness: 118.5 nm) are sequentially formed on a soda-lime glass substrate with a thickness of 1.1 mm. Subsequently, reverting the substrate, a TiO₂ film (film thickness: 13.8 nm) and a MgF₂ film (film thickness: 46.7 nm) are formed, and similarly, a TiO₂ film (film thickness: 19.5 nm) and a MgF₂ film (film thickness: 46.7 nm) are formed, and a TiO₂ film (film thickness: 19.5 nm) and a MgF₂film (film thickness: 72.8 nm). After that an ITO film (film thickness: 15.0 nm) is formed to obtain a laminate film as shown in Table 1.

FIG. 3 shows measurement result of transmittance of the laminate film, and Table 2 shows average transmittance as well as a* value and b* value. Average transmittance in the visible wavelength range is high to be 97.5% and the light color passing the film is achromatic.

### COMPARATIVE EXAMPLE 1

To compare with the examples of the invention, by using the spattering method as described in Example 1, a single layer of a SiO₂ film with a film thickness of 30.0 nm, and an ITO film with a film thickness of 20.0 nm are formed on the SiO₂ film to obtain a laminate film as shown in Table 1. This comparative example is one of film constructions of substrates having transparent conductive films that are generally used for touch panel.

The measurement result shows that transmittance of this comparative example is small as compared with the inventive examples as described above as shown in FIG. 4. Table 2 shows average transmittance as well as a* value and b* value of this comparative example. The average transmittance is low to be 87.1% and the b* value is large and the light color passing the film is yellow.

### COMPARATIVE EXAMPLE 2

By using the spattering method as described in Example 1, a TiO₂ film with a film thickness of 100.0 nm and a SiO₂ film with a film thickness of 30.0 nm are formed on a soda-lime glass substrate with a thickness of 1.1 mm, and an ITO film with a film thickness of 23.0 nm are formed on the SiO₂ film to obtain a laminate film as shown in Table 1. This example improve the transmittance from the comparative example 1 by sequentially forming a refractive index layer, low refractive index layer and transparent conductive film as described in JP H07-242442A as mentioned above. FIG. 4 shows measurement result of transmittance of the laminate film, and Table 2 shows average transmittance as well as a* value and b* value. Although the transmittance is improved from the comparative example 1, the light color passing the film is yellow-tinged.

### COMPARATIVE EXAMPLE 3

By using the spattering method as described in Example 1, a TiO₂ film (flim thickness: 13.1 nm), a SiO₂ film (film thickness: 46.3 nm), a TiO₂ film (film thickness: 17.8 nm) and a SiO₂ film (film thickness: 106.0 nm) are sequentially formed on a soda-lime glass substrate with a thickness of 1.1 mm. Then, reverting the substrate, a TiO₂ film (film thickness: 12.4 nm), a SiO₂ film (film thickness: 28.9 nm), a TiO₂ film (film thickness: 140.0 nm), a SiO₂ film (film thickness: 42.3 nm), and an ITO film (film thickness: 20.0 nm) are sequentially formed to obtain a laminate film as shown in Table 1. This comparative example has the similar construction to the inventive examples in that four layers of dielectric films are formed on the opposite sides of the substrate. However, the film thickness of the third layer (TiO₂ film) on the side of the transparent conductive film is formed thicker as compared with the example 1.

FIG. 4 shows measurement result of transmittance of the laminate film, and Table 2 shows average transmittance as well as a* value and b* value. The transmittance of this comparative example is high in the visible wavelength range. However, the transmittance change is high showing a significant peak. Moreover, the absolute value of the a* value is high and the b* value shows a negative value, so that the light color passing the film is observed to be green-tinged.

[Summary of the Desirable Construction]

According to the foregoing examples, in the touch panel of the invention, on opposite surfaces of a transparent substrate having a refractive index of 1.45-1.70, it is preferable to sequentially form a high refractive index dielectric film having a refractive index of 1.6-2.5 with a thickness in a range of 7-45 nm as first layer, a low refractive index dielectric film having a refractive index of 1.35-1.50 with a thickness in a range of 10-63 nm as second layer, a high refractive index dielectric film having a refractive index of 1.6-2.5 with a thickness of 9-125 nm as third layer, and a low refractive index dielectric film having a refractive index of 1.35-1.50 with a thickness in a range of 20-130 nm as fourth layer, as counted from the surface of the substrate.

Further, on one surface of the substrate, it is preferable that a transparent conductive film having a refractive index in a range of 1.7-2.2 is formed as fifth layer with a film thickness in a range of 10-30 nm. However, it is necessary to select the refractive index of the transparent substrate to be higher than those of the first and third layers and the refractive index of the transparent conductive film to be higher than those of the second and fourth layers.

More specifically, for the transparent dielectric film provided on the outer side of the touch panel where the transparent conductive film is not provided, it is preferable that the film thickness of the first layer is in a range of 7-18 nm, the film thickness of the second layer is in a range of 37-63 nm, the film thickness of the third layer is in a range of 9-23 nm, the film thickness of the fourth layer is in a range of 81-130 nm.

Further, for the transparent dielectric film on the transparent conductive film side, it is preferable that the film thickness of the first layer is in a range of 10-18 nm, the film thickness of the second layer is in a range of 21-35 nm, the film thickness of the third layer is in a range of 96-119 nm, the film thickness of the fourth layer is in a range of 33-51 nm corresponding to Examples 1 and 2, and it is also preferable that the film thickness of the first layer is in a range of 10-18 nm, the film thickness of the second layer is in a range of 37-56 nm, the film thickness of the third layer is in a range of 14-25 nm, the film thickness of the fourth layer is in a range of 56-85 nm corresponding to Examples 3 and 4.

In the invention, by forming dielectric films on opposite surfaces of the substrate, light color in passing the substrate can be corrected by properly design the film construction for each film. Accordingly, it is possible to realize achromatic light color in passing the substrate while maintaining a high transmittance.

If the values fall outside the above-described ranges, a peak may appear in the transmittance spectrum even if a four-layered dielectric film construction is used, and the a* value and b* value become high so that the coloring of the film could happen.

If the a* value and b* value are in a range of −1 through +1, the film construction is preferable since the coloring of the film is hardly observed in the examples.

It is preferable that the transmittance of the substrate for visible light wavelength range (400 nm-650 nm) is not less than 95% on average. If the film constructions fall outside of the above-described ranges, such a high transmittance could not be obtained.

Conventionally, a layer of SiO₂ film has been provided between the surface of the second transparent substrate 22 and the transparent conductive film 35. However, a four-layered transparent dielectric film may be formed on opposite surfaces of the second substrate 22. By this construction, the transmittance can be further improved as compared with a case that a four-layered dielectric film is formed only on the surface on the first transparent substrate side, and the coloring can be further suppressed.

TABLE 1

| | |
|---|---|
| Example 1 | S(106.0 nm)/T(17.8 nm)/S(46.3 nm)/T(13.1 nm)/G/ |
| | T(12.4 nm)/S(28.9 nm)/T(106.8 nm)/S(42.3 nm)/ |
| | I(20.0 nm) |
| Example 2 | M(118.0 nm)/T(14.0 nm)/M(50.8 nm)/T(11.4 nm)/G/ |
| | T(13.7 nm)/M(26.7 nm)/T(107.9 nm)/M(42.4 nm)/ |
| | I(20.0 nm) |
| Example 3 | S(108.4 nm)/T(16.2 nm)/S(51.2 nm)/T(11.6 nm)/G/ |
| | T(13.6 nm)/S(47.1 nm)/T(20.8 nm)/S(70.5 nm)/ |
| | I(15.0 nm) |
| Example 4 | M(118.5 nm)/T(13.5 nm)/M(52.8 nm)/T(10.5 nm)/G/ |
| | T(13.8 nm)/M(46.7 nm)/T(19.5 nm)/M(72.8 nm)/ |
| | I(15.0 nm) |
| Comparative | G/S(30.0 nm)/I(20.0 nm) |
| Example 1 | |
| Comparative | G/T(100.0 nm)/S(30.0 nm)/I(23.0 nm) |
| Example 2 | |
| Comparative | S(106.0 nm)/T(17.8 nm)/S(46.3 nm)/T(13.1 nm)/G/ |
| Example 3 | T(12.4 nm)/S(28.9 nm)/T(140.0 nm)/S(42.3 nm)/ |
| | I(20.0 nm) |

T: TiO₂
S: SiO₂,
M: MgF₂,
I: ITO
G: Soda-lime glass substrate

TABLE 2

| | Average Transmittance | Chromatic Coordinate | |
|---|---|---|---|
| | (%) | a* | b* |
| Example 1 | 96.5 | −0.09 | 0.52 |
| Example 2 | 97.4 | −0.06 | 0.20 |
| Example 3 | 96.3 | −0.10 | 0.82 |
| Example 4 | 97.5 | −0.02 | 0.57 |
| Comparative Example 1 | 87.1 | −0.49 | 1.97 |
| Comparative Example 2 | 89.9 | 0.36 | 4.33 |
| Comparative Example 3 | 93.5 | −1.80 | −0.53 |

What is claimed is:

1. A touch panel comprising:
a first transparent substrate provided with a transparent conductive film on one surface thereof;
a second transparent substrate provided with a transparent conductive film on one surface thereof, said first substrate and said second substrate being fixed in parallel with each other so that said transparent conductive films are opposed to each other; and
a supporting member to regulate a distance between said opposite substrates;
wherein said transparent conductive films of said first and second transparent substrates are brought into contact with each other to be electrically connected when said first transparent substrate is bent by being locally pressed on an opposite surface to the surface of said first substrate on which said transparent conductive film is provided, and
wherein, in at least one of said first and second transparent substrates, a first four-layered transparent dielectric film is formed between a surface of the corresponding transparent substrate on a side of which the transparent conductive film is provided and said transparent conductive film, a second four-layered transparent dielectric film is formed on an opposite surface to the surface on which the transparent conductive film is formed.

2. A touch panel according to claim 1, wherein a refractive index of said corresponding transparent substrate is in a range of 1.45-1.70, refractive indices of a first layer and a third layer in said first and second transparent dielectric films that are counted from the surface of said corresponding transparent substrate are in a range of 1.6-2.5, refractive indices of a second layer and a fourth layer are in a range of 1.35-1.5, and a refractive index of said transparent conductive film is in a range of 1.7-2.2;
the refractive indices of said first layer and third layer are selected to be higher than the refractive indices of said transparent substrate, said second layer and said fourth layer, and the refractive index of said transparent conductive film is selected to be higher than the refractive index of said fourth layer in said first and second transparent dielectric films; and
a film thickness of said first layer in said first and second transparent dielectric films is in a range of 7-45 nm, a film thickness of said second layer is in a range of 10-63 nm, a film thickness of said third layer is in a range of 9-125 nm, a film thickness of said fourth layer is in a range of 20-130 nm, and a film thickness of said transparent conductive film is in a range of 10-30 nm.

3. A touch panel according to claim 2, wherein the film thickness of said first layer is in a range of 7-18 nm, the film thickness of said second layer is in a range of 37-63 nm, the film thickness of said third layer is in a range of 9-23 nm, the film thickness of said fourth layer is in a range of 81-130 nm in said second transparent dielectric film.

4. A touch panel according to claim 2, wherein the film thickness of said first layer is in a range of 10-18 nm, the film thickness of said second layer is in a range of 21-35 nm, the film thickness of said third layer is in a range of 96-119 nm, the film thickness of said fourth layer is in a range of 33-51 nm in said first transparent dielectric film.

5. A touch panel according to claim 2, wherein the film thickness of said first layer is in a range of 10-18 nm, the film thickness of said second layer is in a range of 37-56 nm, the film thickness of said third layer is in a range of 14-25 nm, the film thickness of said fourth layer is in a range of 56-85 nm in said first transparent dielectric film.

6. A touch panel according to claim 1, wherein chromatics indexes a* value and b* value derived for light C with 2 degrees of view angle that is transmitted through said transparent substrate on opposite surfaces of which said transparent dielectric films are laminated, are in a range of −1 through +1 based on an indication method of a body color according to a color representation system of L*a*b* provided by Japanese Industrial Standards (JIS z 8729).

7. A touch panel according to claim 6, wherein an average transmittance for light having a wavelength range of 400-650 nm to said transparent substrate on opposite surfaces of which said transparent dielectric films are laminated is not less than 95%.
